(19) United States
(12) Patent Application Publication
(10) Pub. No.: US 2010/0162230 A1
(43) Pub. Date: Jun. 24, 2010

(54) DISTRIBUTED COMPUTING SYSTEM FOR LARGE-SCALE DATA HANDLING

(75) Inventors: Peiji Chen, Saratoga, CA (US); Donald Swanson, Mountain View, CA (US); Mark Sordo, Santa Cruz, CA (US); Danny Zhang, Mountain View, CA (US); Long Ji Lin, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/343,979

(22) Filed: Dec. 24, 2008

(51) Int. Cl. G06F 17/30; G06F 7/00

(52) U.S. Cl. 717/177; 707/E17.032

(57) ABSTRACT

A method for processing data on a distributed computing environment is provided. Input data that is to be processed may be stored on an input storage module. Mapper code can be loaded onto a map module and executed. The mapper code can load a mapper executable file onto the map module from a central storage unit and instantiate the mapper executable file. The mapper code, then, can pass the input data to the mapper executable file. The mapper executable file can generate mapped data based on the input data and pass the mapped data back to the mapper code.

### BACKGROUND

In many instances, scripts can be run on distributed computing systems to process large volumes of data. One such distributed computing system is Hadoop. Programs for Hadoop are written in Java with a map/reduce architecture. The programs are prepared on local machines but are specifically generated as Hadoop commands. The programs are, then, transferred (pushed) to a grid gateway computers where the programs are stored temporarily. The programs are then executed on the grid of computers. While map/reduce programming provides a tool for large scale computing, in many applications the map/reduce architecture cannot be utilized directly due to the complex processing required. Also, many developers prefer to use other programming languages like perl, C++ for heavy-processing jobs on their local machines. Accordingly, many developers are looking for a way to utilize distributed computing systems as a resource for their familiar languages or tools.

### SUMMARY

In satisfying the drawbacks and other limitations of the related art, the present application provides an improved method and system for distributed computing.

According to the method, input data may be stored on an input storage module. Mapper code can be loaded onto a map module and executed. The mapper code can load a mapper executable file onto the map module from a central storage unit and instantiate the mapper executable file. The mapper code, then, can pass the input data to the mapper executable file. The mapper executable file can generate mapped data based on the input data and pass the mapped data back to the mapper code.

In another aspect of the system, a reducer module can also be configured in a similar manner. In such a system, reducer code can be loaded onto a reducer module and executed. The reducer code can load a reducer executable file onto the reducer module and instantiate the reducer executable file. The reducer module can then pass the mapped data from the map module to the reducer executable file to generate result data. The result data may be passed back to the reducer code and stored in a result storage module.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a grid computing system according to one embodiment of the present application;

FIG. 2 is a flowchart illustrating a method of operation for a grid computing system;

FIG. 3 is a schematic view of a grid computing system according to one embodiment of the present application; and

FIG. 4 is a schematic view of a computer system for implementing the methods described herein.

### DETAILED DESCRIPTION

To address the issued noted above, a pushing mechanism and Hadoop streaming can be used to wrap all heavy-processing executable components together with their local dependent data and libraries that are developed off-the grid using for example, perl or C++. A push script can set up an environment and run executable files through Hadoop streaming to leverage computing clusters for both map/reduce and non-map/reduce computing. As such, conventional code can also be used for large scale computing on the Grid. With a good planning, many heavy-duty computing components developed off-the-grid may be reused through the pushing scripts.

In this information age, data is essential for understanding customer behaviors and for making business decisions. Most big web related companies like YAHOO!, Inc., AMAZON.COM, Inc., and EBAY Inc. spend an enormous amount of resources to build their own data warehouses for user tracking and decision-making purposes. Usually the amount of data collected from weblogs is in the scale of terabytes or peta bytes. There is a huge challenge in processing such a large amount of data on a daily basis.

Since the debut of the Hadoop system, developers have leveraged this parallel computing system for the processing of large data applications. Hadoop is an open-source, java-based, high performance parallel computing infrastructure that utilizes thousands of commodity PCs to produce significant amount of computing power. Map/reduce is the common program style used for code development in the Hadoop system. It is also a software framework introduced by GOOGLE, Inc. to support parallel computing over large data sets on clusters of computers. Equipped with the Hadoop system and map/reduce framework, many engineers, researchers, and scientists who need to process large data sets are migrating from proprietary clusters to standard distributed architectures, such as the Hadoop system. There is a need to let developers work in a preferred environment, but provide a way to push the application to a distributed computer environment when large data sets are processed.

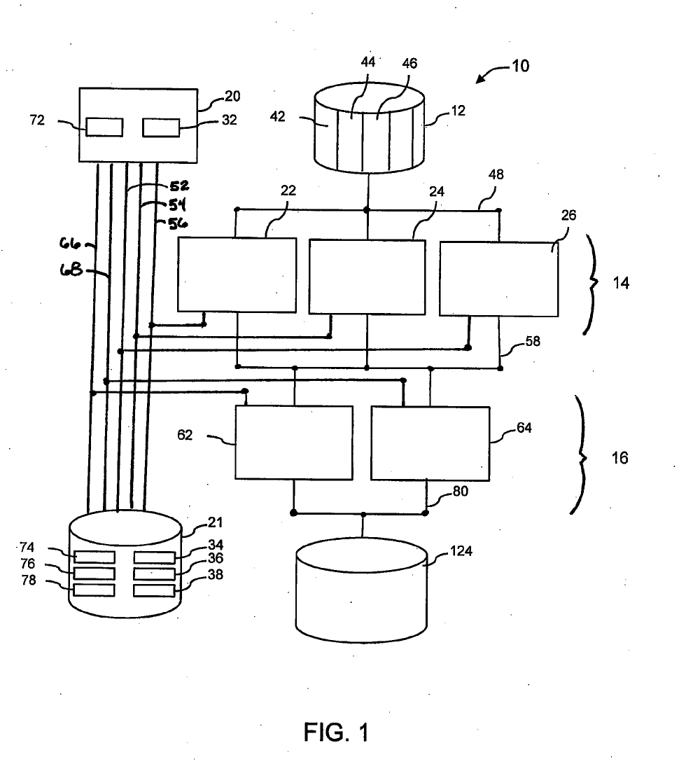

Now referring to FIG. 1, a distributed computing system 10 is provided. The distributed computing system 10 includes an input data storage module 12, map modules 14, reduce modules 16, a result data storage module 18, and a master module 20. Many distributed computing systems distribute processing by dividing the data into splits. Each split of data may then be operated on by a separate hardware system. The logical architecture implemented by the distributed computing systems is a map/reduce architecture. The map modules 14 operate on the data to map the data from one form to another. For example, an IP address may be mapped into a zip code or other geographic code using a mapping algorithm. Each, IP address can be operated on independently of the other IP addresses. Then, the reduce modules 16 can be used to consolidate the information from one or more mapping modules. For example, determining the percentage of entries in the data that correspond to each zip code. This is information that is dependent on the other IP addresses in the data store. The results may then be written out to a result data storage module 18.

The master module 20 coordinates which computer system is used for a particular mapping or reducing algorithm. The master module 20 also coordinates setting up for each computer system and the routing of data from one computer system to another computing system. The master module 20 is able to coordinate the modules based on some basic structural rules without knowing how each map module 14 or reduce module 16 manipulates the data. The data is packaged and transferred between modules in key/value pairs. In addition, the flow is generally expected to model a map/reduce flow with splits of the input data being provided to each map module 14 and result data being provided from the reduce modules 16. However, each map and reduce module 14, 16 acts as a black box to the master module 20, as such the master module 20 does not need to know what type of processing occurs with each map and reduce module 14, 16. The structure provided in FIG. 1 is only exemplary and the number of mapping modules 14 and reducing modules 16 can be scaled to accommodate different data requirements for each application. In addition, it is understood that multiple map/reduce flows can be chained together for more complex processing algorithms or iterative processes. One popular distributed computing system that may be used is, for example the Hadoop computing environment.

Referring again to FIG. 1, the input data module 12 may be divided into multiple data splits, such as data split 42, 44, and 46. The size and number of the data splits 42, 44, and 46 may be selected based on predefined parameters stored in the master module 20 during upload of the application to the distributed computing system 10. Based on the status of the various computer systems available to the master module 20, the master module 20 will select certain computers to operate as mapping module 14 and other computers to operate as reducing modules 16. For example, computer 22 is in communication with the master module 20, as denoted by line 56. The master module 20 may download the mapper code 32 to the computer 22 for execution. Typically, the mapper code is self contained and written in the Java programming language. In one embodiment of the present application, the mapper code 32 may be a unix script or similar macro that downloads ancillary files including executable files 34, library files 36, and data files 38 from a central storage module 21. Using the unix script in the mapper code 32 to download the ancillary files 34, 36, 38 and instantiate the executable files 34, significantly reduces the time requirements on master module 20 and allows the developer to utilize executable files 34 and library files 36 that would otherwise need to be recoded into a language supported by the distributed computing system 10.

Similar to computer 22, the computer 24 is in communication with the master module 20, as denoted by line 54. The master module 20 may download the mapper code 32 to the computer 24 for execution. The mapper code 32 downloads ancillary files including executable files 34, library files 36, and data files 38 from the central storage module 21. In addition, the computer 26 is in communication with the master module 20, as denoted by line 52. The master module 20 may download the mapper code 32 to the computer 26 for execution. The mapper code 32 downloads ancillary files including executable files 34, library files 36, and data files 38 from the central storage module 21 to computer 26.

The communication between each computer, including master module 20, as well as the input data storage module 12 and the result data storage module 18 may be implemented via a wired or wireless network, including but not limited to Ethernet and similar protocols and, for example, may be over the internet, local area networks, or other wide area networks. Other communication paths or channels may be included as well, but are not shown so as to not unduly complicate the drawing.

Within the standard framework of the distributed computing system 10, the mapping modules are also provided with the input data from the input data storage module 12. Accordingly, the computer 22 receives the data split 42, the computer 24 receives the data split 22, and the computer 26 receives the data split 46. The data splits 42, 44, and 46 are transferred to the computers 22, 24, and 26, respectively, in key/value format. Each computer 22, 24, and 26, runs the mapper code 32 to manipulate the input data. As discussed above, the mapper code 32 may download and run an executable file 34. The executable file 34, when instantiated may create a buffer or data stream and pass a pointer to the stream back to the mapper code 32. As such, the input data from the mapper code 32 is passed through the stream to the executable file 34 where it may be manipulated by the executable file 34 and/or library files 36 and retrieved by the mapper code 32 through the stream. In addition, the executable file 34 and/or library files 36 may manipulate the input data based on data files 38, such as look up tables, algorithm parameters, or other such data entities. The manipulated data or mapped data may be passed by the mapper code 32 to one or more of the reduce modules 16. The manipulated data may be transmitted directly to the reduce modules 16 in key/value format, or alternatively may be stored on the network into an intermediate data storage (not shown) where it can be retrieved by the reduce modules 16.

Similarly, the master module 20 can assign computer 62 and computer 64 as reducer modules 16. Computer 62 is in communication with the master module 20, as denoted by line 66. The master module 20 may download the reducer code 72 to the computer 62 for execution. Typically, the reducer code is self contained and written in the Java programming language. In one embodiment of the present application, the reducer code 72 may be a unix script or similar macro that downloads ancillary files including executable files 74, library files 76, and data files 78 from the central storage module 21. Using the unix script in the reducer code 72 to download the ancillary files 74, 76, 78 and instantiate the executable files 74, significantly reduces the time requirements on the master module 20 and allows the developer to utilize executable files 74 and library files 76 that would otherwise need to be recoded into a language supported by the distributed computing system 10.

Similar to computer 62, the computer 64 is in communication with the master module 20, as denoted by line 68. The master module 20 may download the reducer code 72 to the computer 64 for execution. The reducer code 72 downloads ancillary files including executable files 74, library files 76, and data files 78 from the central storage module 21. Within the standard framework of the grid computing system 10, the reducer modules 16 are also provided with the data from mapper modules 14, as denoted by line 58. The data is transferred from the computers 22, 24, and 26 to computers 62 and 64 in key/value format. Each computer 62, 64 runs the reducer code 72 to manipulate the data from the mapper modules 14. As discussed above, the reducer code 72 may download and run an executable file 74. The executable file 74, when instantiated may create a buffer or data stream and pass a pointer to the stream back to the reducer code 72. As such, the input data from the reducer code 72 is simply passed to the executable file 74 where it may be manipulated by the executable file 74 and/or library files 76 and retrieved by the reducer code 72 through the stream. In addition, the executable file 74 and/or library files 76 may manipulate the data from the mapper modules 14 based on data files 78, such as look up tables, algorithm parameters, or other such data entities. The reduced data may be stored in the result data store 18 by the reducer code 72.

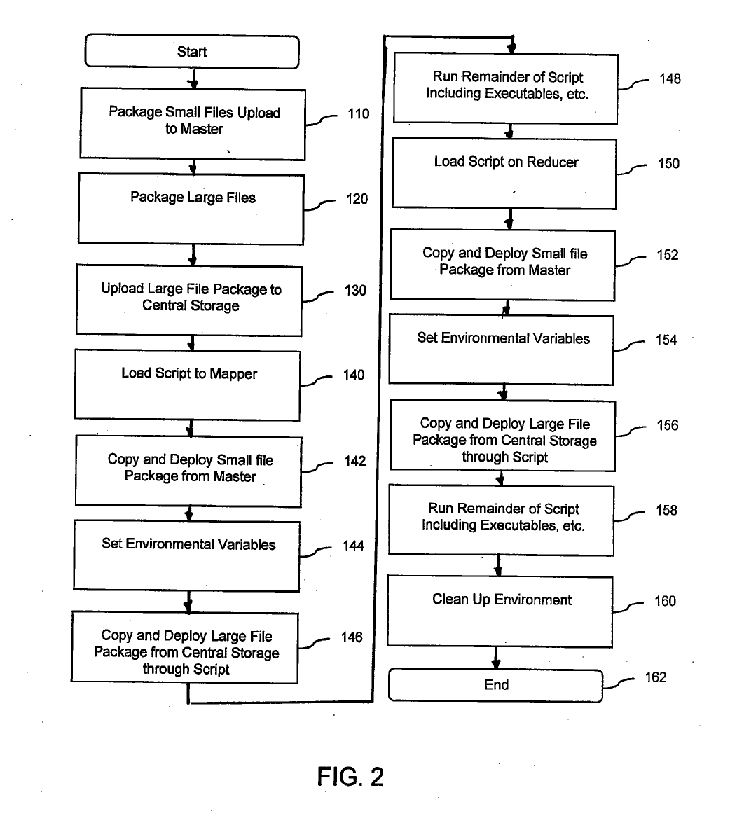

One method for implementing the distributed computing system is provided in FIG. 2. While the implementation in FIG. 2 will discuss an implementation relative to a Hadoop distributed computing environment, it is readily understood that the same principles may be applied to other distributed computing environments.

The following paragraphs are steps to wrap the executable files and library files and push them into a Hadoop system. A push script may be written for a local development computer to control the Hadoop scripts described below. The push script may use Hadoop streaming commands to pass input data to the mapper code defined below in block 140 where non-map/reduce code is wrapped with Unix shell commands. The push script may be run from the local development computer by issuing a remote call to the Hadoop system. Alternatively, the steps may be performed manually in a less efficient manner.

In block 110, dependent libraries are packaged into a tar file for deployment. Typically library files are relatively small and can be easily tarred into an archived file. When deployed into the Hadoop system, the library files will be copied and unpackaged into each computing node by the Hadoop system automatically. As such, it is suggest that small files are stored within the Hadoop system.

In block 120, large data sets, large tool files, executable files, large library files, etc. into a big package file (usually in tar format). Typically, the large files are required resources to run the needed algorithm. Sometimes the packaged resource file can be many gigabytes or larger. It would not be feasible to copy and deploy such a large file into each Hadoop computing node, as this will take up precious network bandwidth from the Hadoop system's master module. In block 140 and block 150, an innovative way to solve the issue of deploying large required packages into each computing node is provided without taking up much of network bandwidth of the Hadoop system master module.

In block 130, the standard Hadoop load command can be used to load the large package, generated in block 120, to a central Hadoop storage place so that each computing node can access this package file during the run time.

In block 140, a simple unix shell script is provided for the mapper module that executes blocks 142 to 148. It should be noted that the Mapper can run in any Hadoop machine as each machine supports running a unix shell script by default.

Inside the mapper module, the library package from block 110 will be copied/deployed to the mapper computers, then the library package will be unpackaged in each computing module so that the code can run with the corresponding dependent libraries and tools, as denoted by block 142.

In block 144, all environment variables required by the code are set by the mapper code.

Inside the mapper code, the standard Hadoop fetching command may be used to get the large package from block 120 and copy it onto each computing module, as denoted by block 146. Fetching the large packages by each mapper module happens in parallel and utilizes the Hadoop infrastructure very well without putting a significant burden on the Hadoop system's master module, which is the bottleneck of processing.

In block 148, the code runs as if the code was executed in a standalone development computer. The mapper code is able to run independently since all dependent data, executable files, and libraries were downloaded and deployed in the above steps.

In block 150, a simple unix shell script is provided for the reducer module that executes blocks 152 to 158. It should be noted, that the reducer code can run in any Hadoop machine as each machine supports running a unix shell script by default.

Inside the reducer module, the library package from block 110 will be copied/deployed to the reducer computers, then the library package will be unpackaged in each computing module so that the code can run with the corresponding dependent libraries and tools, as denoted by block 152.

In block 154, all environment variables required by the code are set by the reducer code.

Inside the reducer code, the standard Hadoop fetching command may be used to get the large package from block 120 and copy it onto each computing module, as denoted by block 156. Fetching the large packages by each reducer module happens in parallel and utilizes the Hadoop infrastructure very well without putting a significant burden on the Hadoop system's master module, which is the bottleneck of processing.

In block 158, the code runs as if the code was executed in a standalone development computer. The reducer code is able to run independently because all dependent data, executable files, and libraries were downloaded and configured in the above steps.

After each mapper code and reducer code has successfully executed, the mapper code and reducer code removes the library files and other files from the large package, as denoted in block 160. The master module is then able to reassign the computer to another task. The method ends in block 162.

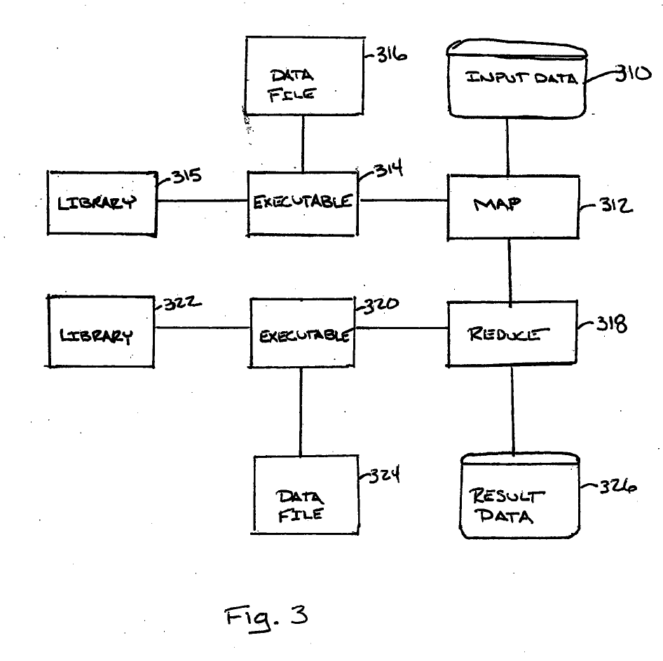

To illustrate one implementation of the push mechanism the following example is given with regard to FIG. 3. In this example, an ad server's log data needs to be processed including approximately 250 GB/day (compressed) or 1.5 TB/day (uncompressed) of entries. The log data may record how many advertisement impressions YAHOO!, Inc., served for advertisers from its web sites; hence the data could be used for billing purposes and for impression inventory predication as well. To better understand the impression inventory, a few fields need to be mapped and analyzed. For example, the log may store the IP address for the impression. The IP address may be mapped into a ZIP code, state and country for targeting purpose. Therefore, a decoder is needed to interpret those fields into more meaningful terms like geographical locations, demographical attributes, etc. In this example, three developers generated thousands of lines of C++ code over six months to perform these mapping algorithms. In addition, these mapping algorithms utilize more than 10 proprietary tools/libraries. The mapping files themselves are nearly 10 GB (uncompressed). Further, the mapping algorithm was developed in non-map/reduce framework. Based on the above facts, it would be not be feasible to rewrite the whole algorithm again specifically for a Hadoop system, and some libraries cannot be ported into the Hadoop system. In this example, the mapping algorithm on a local computer can provide excellent performance for small data sets. However, on large data logs it would be beneficial to utilize the Hadoop computing power without modifying the legacy code so that Tera- or Peta-bytes of data can be processed efficiently.

By applying this mechanism for high-performance computing in a distributed computing environment, such as Hadoop, it is possible to reuse previous work, while leveraging vast computing and storage power of the distributed computing system. Further, the wrapping/pushing mechanism can work for nearly any type of code developed under a linux system. In addition, it provides an opportunity for developers to use a preferred language or architecture to develop modules for use on a distributed computer environment even modules designed for complicated non-map/reducer problems.

FIG. 3, illustrates the implementation of one mapper module 312 and one reducer module 318 for the scenario described above. Although, one can clearly understand the additional mapper and/or reducer modules could be utilized together in the manner illustrated in FIG. 1. The input data storage module 310 includes the log data, for example the IP address for each impression. A split of data from the input data storage module 310 is provided to the mapper module 312. The mapper module 312 runs the mapper code, for example the unix shell to download, unpack, and instantiate the executable files 314, as discussed above. The executable files 314 may return a pointer to a data stream initialized by the executable files 314. The mapper code in the mapper module 312 may pass log data in key/value format to the executable files 314 over the stream. In this instance, the key/value format may take the form of impression/IP address. The executable files 314 may manipulate the log data, for example convert the IP address to a zip code. The executable files 314 may make calls to library files 315 or data tables 316 to aid in the transformation from IP address data to the zip code data. As discussed above, the library files 315 and data tables 316 may be downloaded, unpacked, and instantiated together with the executable files 314. After the executable file 314 has obtained the impression/zip code data, the impression/zip code data may be passed back to the mapper module 312. The mapper module 312 can then pass the impression/zip code data to the reducer module 318. The impression/zip code data may be passed directly to the reducer module 318 based on configuration information provided by the master module, or alternatively store the information in an intermediate file for retrieval by the reducer module 318.

The reducer module 318 runs the reducer code, for example the unix shell to download, unpack, and instantiate the executable files 320, as discussed above. The executable files 320 may return a pointer to a data stream initialized by the executable files 320. The reducer code in the reducer module 318 may pass impression/zip code data to the executable files 320 over the stream. The executable files 320 may manipulate the impression/zip code data, for example determine the percentage of impression in each state or other statistical information, for example related to the geographic region or other demographics. The executable files 320 may make calls to library files 322 or data tables 324 to aid in the transformation from the zip code data to the statistical data. As discussed above, the library files 322 and data tables 324 may be downloaded, unpacked, and instantiated together with the executable files 320. After the executable file 320 has obtained the statistical data, the statistical data may be passed back to the reducer module 318. The reducer module 318 can then pass the statistical data to the result data storage module 326.

As such, the pushing mechanism and streaming described in this application can be utilized to wrap all heavy-duty components with their local dependent data and libraries that are developed off-the grid using perl/C++. A push script can submit the complicated commands through streaming into grid clusters to leverage each grid cluster for both map/reduce and non-map/reduce computing.

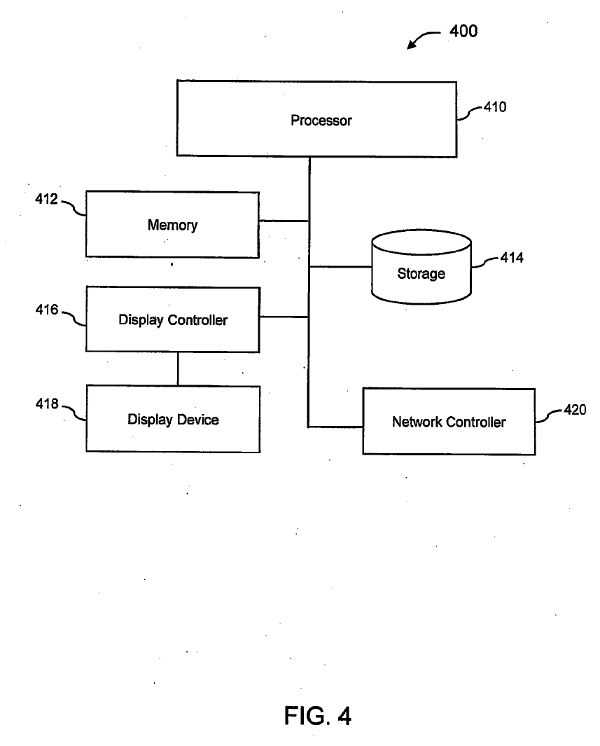

Any of the modules, servers, or engines described may be implemented in one or more general computer systems. One exemplary system is provided in FIG. 4. The computer system 400 includes a processor 410 for executing instructions such as those described in the methods discussed above. The instructions may be stored in a computer readable medium such as memory 412 or a storage device 414, for example a disk drive, CD, or DVD. The computer may include a display controller 416 responsive to instructions to generate a textual or graphical display on a display device 418, for example a computer monitor. In addition, the processor 410 may communicate with a network controller 520 to communicate data or instructions to other systems, for example other general computer systems. The network controller 420 may communicate over Ethernet or other known protocols to distribute processing or provide remote access to information over a variety of network topologies, including local area networks, wide area networks, the internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. a system for processing data on a distributed computing environment, the system comprising:
a input data storage module containing input data from a weblog;
a map module in communication with the input data storage module to receive a split of the input data and configured to execute mapper code for manipulating the input data to generate mapped data.
a reduce module in communication with the map module to receive the map module to receive the mapped data, the reduce module being configured to execute reducer code for analyzing the mapped data and generate result data.
a result data storage module in communication with the reduce module to receive the result data from the reduce module.
a master module for coordinating the selection, set-up, and data flow of the map module and the reduce module, the master module loading the mapper code onto the mapper module and the reducer code onto the reducer module; and
a central storage module containing a mapper executable file and a reducer executable file, wherein the mapper code accesses the central storage module and loads the mapper executable file onto the mapper module and the reducer code loads the reducer executable file onto the reducer module.

2. The system for according to claim 1, wherein the mapper code instantiates the mapper executable file and the mapper executable file initiate a stream for communicating between the mapper code and the mapper executable file.

3. The system for according to claim 2, wherein the mapper code passes the input data to the mapper executable file through the stream in key/value format and the mapper executable file pass the mapped data to the mapper code through the stream in key/value format.

4. The system for according to claim 1, wherein the input data is impression\IP address data.

5. The system for according to claim 4, wherein the mapped data is impression\geographic region data.

6. The system for according to claim 5, wherein the result data is statistical data regarding a geographical region.

7. A method for processing data on a distributed computing environment, the method comprising:
storing input data from a weblog on an input storage module;
loading mapper code onto a map module through a master module;
executing the mapper code on the map module;
loading a mapper executable file onto the map module from a central storage module;
instantiating the mapper executable file on the map module;
retrieving a split of the input data from the input storage module;
passing the input data from the mapper code to the mapper executable file;
manipulating the input data to generate mapped data;
passing the mapped data from the mapper executable file to the mapper code;
loading reducer code onto a reduce module through a master module;
executing the reducer code on the reduce module;
loading a reducer executable file onto the reduce module from a central storage module;
instantiating the reducer executable file on the reduce module;
receiving the mapped data from the map module;
passing the input data from the reducer code to the reducer executable file;
manipulating the mapped data to generate result data;
passing the result data from the reducer executable file to the reducer code; and
storing the result data from the reducer on a result storage module.

8. The method for according to claim 7, wherein the input data is impression\IP address data.

9. The method for according to claim 8, wherein the mapped data is impression\geographic region data.

10. The method for according to claim 9, wherein the result data is statistical data regarding a geographical region.

11. A method for processing data on a distributed computing environment, the method comprising:
storing input data on an input storage module;
loading mapper code onto a map module;
executing the mapper code on the map module;
loading a mapper executable file onto the map module from a central storage module through the mapper code;
instantiating the mapper executable file on the map module;
retrieving a split of the input data from the input storage module;
passing the input data from the mapper code to the mapper executable file;
manipulating the input data to generate mapped data; and
passing the mapped data from the mapper executable file to the mapper code.

12. The method for according to claim 11, wherein the mapper code is a unix shell script.

13. The method for according to claim 11, further comprising loading a mapper library file onto the map module from the central storage module.

14. The method for according to claim 11, further comprising loading a mapper data file onto the map module from the central storage module.

15. The method for according to claim 14, wherein the mapper executable file generates the mapped data from the input data based on the mapper data file.

16. The method for according to claim 15, wherein the mapper data file is a look up table.

17. The method for according to claim 11, wherein the mapper executable file creates a data stream when instantiated and passes a pointer to the stream back to the mapper code.

18. The method for according to claim 14, wherein the input data is passed to the mapper executable over the stream in key/value format and the mapped data is passed to the mapper code over the stream in key/value format.

19. The method for according to claim 11, further comprising:
loading reducer code onto a reduce module;
executing the reducer code on the reduce module;
loading a reducer executable file onto the reduce module from a central storage module through the reducer code;
instantiating the reducer executable file on the reduce module;
receiving the mapped data from the map module;
passing the input data from the reducer code to the reducer executable file;
manipulating the mapped data to generate result data;
passing the result data from the reducer executable file to the reducer code; and
storing the result data from the reducer on a result storage module.

20. A computer readable medium having stored therein instructions executable by a programmed processor for ranking results, the computer readable medium comprising instructions for:
storing input data from a weblog on an input storage module;
loading mapper code onto a map module;
executing the mapper code on the map module;
loading a mapper executable file onto the map module from a central storage module using a fetch instruction in the mapper code;
instantiating the mapper executable file on the map module;
retrieving a split of the input data from the input storage module;
passing the input data from the mapper code to the mapper executable file;
manipulating the input data to generate mapped data;
passing the mapped data from the mapper executable file to the mapper code;
loading reducer code onto a reduce module;
executing the reducer code on the reduce module;
loading a reducer executable file onto the reduce module from a central storage module using a fetch instruction in the reducer code;
instantiating the reducer executable file on the reduce module;
receiving the mapped data from the map module;
passing the input data from the reducer code to the reducer executable file;
manipulating the mapped data to generate result data;
passing the result data from the reducer executable file to the reducer code; and
storing the result data from the reducer on a result storage module.

21. The method for according to claim 20, wherein the input data is impression\IP address data.

22. The method for according to claim 22, wherein the mapped data is impression\geographic region data.

23. The method for according to claim 23, wherein the result data is statistical data regarding a geographical region.
